(19) United States
(12) Patent Application Publication
(10) Pub. No.: US 2022/0267682 A1
(43) Pub. Date: Aug. 25, 2022

(54) ADDITIONAL HEAT SOURCE FOR NAPHTHA CATALYTIC CRACKING

(71) Applicant: SABIC GLOBAL TECHNOLOGIES B.V., Bergen op Zoom (NL)

(72) Inventor: Mayank KASHYAP, Missouri City, TX (US)

(73) Assignee: SABIC GLOBAL TECHNOLOGIES B.V., Bergen op Zoom (NL)

(21) Appl. No.: 17/629,513

(22) PCT Filed: Jul. 30, 2020
(86) PCT No.: PCT/IB2020/057222

§ 371 Date: Jan. 24, 2022

Related U.S. Application Data
(60) Provisional application No. 62/883,063, filed on Aug. 5, 2019.

(51) Int. Cl. C10G 11/18

(52) U.S. Cl. CPC C10G 11/182; C10G 2300/1044; C10G 2400/20; C10G 2400/30

(57) ABSTRACT

Systems and methods for producing olefins and/or aromatics via catalytically cracking a hydrocarbon feed are disclosed. The hydrocarbon feed is cracked in a reaction unit having one or more fluidized bed reactors. The catalyst particles are then separated from at least some of the gas product in a solid-gas separation unit to form separated catalyst particles. Methane is injected into the catalyst regeneration unit. The methane is burnt in the regeneration unit to provide additional heat to the regenerated catalyst such that the regenerated catalyst particles are at a temperature sufficient for the cracking when the regenerated catalyst particles are flowed to the reaction unit.

### CROSS REFERENCE TO RELATED APPLICATIONS

This application claims the benefit of priority of U.S. Provisional Patent Application No. 62/883,063 filed Aug. 5, 2019, which is hereby incorporated by reference in its entirety.

### FIELD OF INVENTION

The present invention generally relates to systems and methods for producing olefins and/or aromatics. More specifically, the present invention relates to systems and methods for producing light olefins and/or BTX (benzene, toluene, and xylene) via catalytic cracking naphtha in a fluidized bed.

### BACKGROUND OF THE INVENTION

Light olefins (C₂ to C₄ olefins) are building blocks for many chemical processes. Light olefins are used to produce polyethylene, polypropylene, ethylene oxide, ethylene chloride, propylene oxide, and acrylic acid, which, in turn, are used in a wide variety of industries such as the plastic processing, construction, textile, and automotive industries. Generally, light olefins are produced by steam cracking naphtha and dehydrogenation of paraffin.

BTX (benzene, toluene, and xylene) are a group aromatics that are used in many different areas of the chemical industry, especially the plastic and polymer sectors. For instance, benzene is a precursor for producing polystyrene, phenolic resins, polycarbonate, and nylon. Toluene is used for producing polyurethane and as a gasoline component. Xylene is feedstock for producing polyester fibers and phthalic anhydride. In the petrochemical industry, benzene, toluene, and xylene are conventionally produced by catalytic reforming of naphtha.

Over the last few decades, the demand for both light olefins and BTX has been consistently increasing. One of the conventional methods for producing light olefins and aromatics (e.g., BTX) includes catalytic cracking of naphtha in a fluidized bed. In the catalytic cracking process, carbon deposit is formed on a catalyst to form a spent catalyst. The spent catalyst of the fluidized bed is separated from the gaseous product and then flowed to a catalyst regeneration unit. The carbon deposit on the catalyst particles are then burnt to regenerate the spent catalyst and transfer heat to the regenerated catalyst. The regenerated catalyst is then flowed back to the fluidized bed reactor for catalytic cracking. However, as the contact time between hydrocarbons and catalyst particles in the fluidized bed is generally short, in order to optimize the yield of light olefins and BTX, the carbon deposit on the spent catalyst is not sufficient to heat up the catalyst particles to desired temperature, resulting in decreased efficiency for producing light olefins and BTX.

Overall, while methods of producing light olefins exist, the need for improvements in this field persists in light of at least the aforementioned drawbacks for the methods.

### BRIEF SUMMARY OF THE INVENTION

A solution to at least some of the above-mentioned problems associated with the production process for light olefins and BTX via catalytic cracking of naphtha has been discovered. The solution resides in a process of producing an olefin and/or an aromatic that includes transferring additional heat to regenerated catalyst via burning natural gas in a catalyst regeneration unit. This can be beneficial for at least heating the regenerated catalyst to an optimized temperature for producing light olefins and BTX, thereby improving the production efficiency. Additionally, the natural gas is injected in a dense phase of the catalyst, which has a solid volume fraction (SVF) in the range of 0.03 to 0.2 with an average catalyst bed density over 100 kg/m³, in the catalyst regeneration unit, to perform flameless combustion, thereby avoiding local explosion or localized fires in the catalyst regeneration unit. Moreover, the natural gas can be injected and combusted in multiple stages, resulting in thorough and even heat distribution through the regenerated catalyst. Therefore, the method of the present invention provides a technical solution to at least some of the problems associated with the currently available methods for producing an olefin and/or an aromatic mentioned above.

Embodiments of the invention include a method of producing an olefin and/or aromatic. The method comprises cracking a hydrocarbon feed, in a reactor comprising a fluidized bed, to form a gas product comprising one or more olefins and/or one or more aromatics. The method further comprises separating catalyst particles from at least some of the gas product to form separated catalyst particles. The method further comprises regenerating the separated catalyst particles, in a catalyst regeneration unit, to form regenerated catalyst particles. The method further still comprises injecting methane into the catalyst regeneration unit through a sparger. The method further comprises burning the methane, in the catalyst regeneration unit, and thereby heating the separated catalyst particles and/or the regenerated catalyst particles. The method further still comprises sending the regenerated catalyst particles to the reactor at a temperature such that the temperature in the reactor is sufficient for the cracking.

Embodiments of the invention include a method of producing an olefin and/or aromatic. The method comprises cracking a hydrocarbon feed, having an initial boiling point in a range of 30° C. to 70° C., in a reactor comprising a fluidized bed, to form a gas product comprising one or more of ethylene, propylene, butylene, benzene, toluene, and xylene. The method further comprises separating catalyst particles from at least some of the gas product to form separated catalyst particles. The method further comprises regenerating the separated catalyst particles, in a catalyst regeneration unit, to form regenerated catalyst particles. The method further still comprises injecting methane into the catalyst regeneration unit through a sparger. The method further comprises burning the methane, in the catalyst regeneration unit, and thereby heating the separated catalyst particles and/or the regenerated catalyst particles. The method further still comprises sending the regenerated catalyst particles to the reactor at a temperature such that the temperature in the reactor is sufficient for the cracking.

Embodiments of the invention include a method of producing an olefin and/or aromatic. The method comprises cracking a hydrocarbon feed, comprising primarily naphtha, in a circulating fluidized bed reactor, to form a gas product comprising one or more of ethylene, propylene, butylene, benzene, toluene, and xylene. The method further comprises separating catalyst particles from at least some of the gas product to form separated catalyst particles. The method further comprises regenerating the separated catalyst particles, in a catalyst regeneration unit, to form regenerated catalyst particles. The method further still comprises injecting methane into the catalyst regeneration unit through a sparger. The method further comprises burning the methane, in the catalyst regeneration unit, and thereby heating the separated catalyst particles and/or the regenerated catalyst particles. The method further still comprises sending the regenerated catalyst particles to the circulating fluidized bed reactor at a temperature such that the temperature in the circulating fluidized bed reactor is sufficient for the cracking.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a schematic diagram of a system for producing an olefin and/or an aromatic, according to embodiments of the invention;

FIG. 2 shows a schematic diagram of a catalyst regeneration unit, according to embodiments of the invention; and

FIG. 3 shows a schematic flowchart of a method of producing an olefin and/or an aromatic, according to embodiments of the invention.

### DETAILED DESCRIPTION OF THE INVENTION

Currently, aromatics, especially BTX, and light olefins can be produced by catalytic cracking of naphtha. In this process, the hydrocarbons make contact with catalyst particles in a fluidized catalyst bed to crack the hydrocarbons and form carbon deposit on the catalyst particles. After the catalyst particles flow out of the fluidized bed reactor, the catalyst particles with carbon deposit are regenerated in a catalyst regeneration unit. In the regenerating step, the carbon deposit on the catalyst particles is removed via combustion and the released heat from the combustion in turn heats up the regenerated catalyst, which is recycled back to the fluidized bed reactor. However, because the contact time between the hydrocarbons and the catalyst particles in the fluidized bed reactor is relatively short, the amount of carbon deposit formed on the catalyst particles is often not enough to provide sufficient heat to restore the regenerated catalyst to the desired reaction temperature. Thus, the light olefins and BTX production efficiency is reduced by using the regenerated catalyst. The present invention provides a solution to this problem. The solution is premised on a method including injecting methane in the catalyst regeneration unit and burning the methane in the catalyst regeneration unit to provide additional heat to the regenerated catalyst. Thus, the regenerated catalyst is at an optimized temperature for producing light olefins and BTX in the catalytic cracking unit. Furthermore, the methane is injected and combusted at a dense phase of the catalyst in the catalyst regeneration unit, thereby avoiding occurrence of flames and explosion in the catalyst regeneration unit. These and other non-limiting aspects of the present invention are discussed in further detail in the following sections.

### A. System for Producing Olefins and BTX

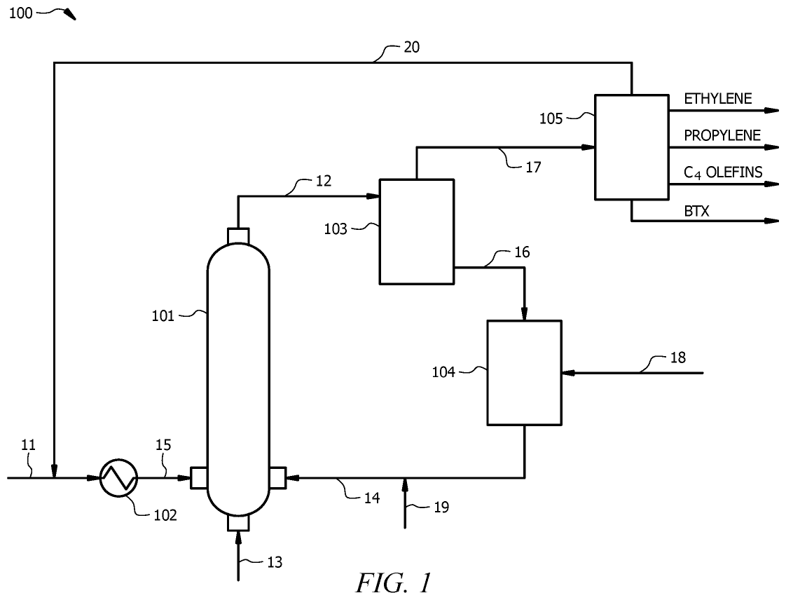

In embodiments of the invention, the system for producing an olefin and/or an aromatic can include a fluidized bed reaction unit, a solid-gas separation unit, a catalyst regeneration unit, and a product separation unit. With reference to FIG. 1, a schematic diagram is shown of system 100 that is configured to produce olefins and aromatics with improved carbon efficiency and energy efficiency compared to conventional processes. According to embodiments of the invention, system 100 includes fluidized bed reaction unit 101 configured to catalytically crack hydrocarbons of feed stream 11 to produce olefins and/or aromatics.

According to embodiments of the invention, fluidized bed reaction unit 101 includes one or more fluidized bed reactors. Each of the fluidized bed reactors may include a shell. In embodiments of the invention, the shell is made of a material comprising stainless steel, carbon steel, or any suitable material known in the art, or combinations thereof In embodiments of the invention, each of the fluidized bed reactors includes a feed inlet disposed on the shell configured to receive feed stream 11 into the shell. In embodiments of the invention, feed stream 11 may include naphtha with a final boiling point lower than 250° C. In embodiments of the invention, each of the fluidized bed reactors includes an outlet disposed on the shell configured to release effluent stream 12 from the shell. According to embodiments of the invention, each of the fluidized bed reactors includes a catalyst inlet disposed on the shell. In embodiments of the invention, the catalyst inlet is configured to receive a catalyst of catalyst stream 14 into the shell.

According to embodiments of the invention, one or more of the fluidized bed reactors is a riser reactor and each of the riser reactors further comprises a lift gas inlet disposed at the lower half of the shell. The lift gas inlet is configured to receive lift gas stream 13 into the shell. In embodiments of the invention, the lift gas inlet may be disposed at a position lower than the feed inlet and the catalyst inlet. Non-limiting examples of the lift gas include nitrogen, methane, any inert gas, steam, or combinations thereof. Lift gas stream 13 may or may not include steam. In embodiments of the invention, lift gas stream 13 includes less than 5 wt. % steam. In embodiments of the invention, fluidized bed reactors of fluidized bed reaction unit 101 include one or more circulating fluidized bed reactors.

In embodiments of the invention, each of the one or more fluidized bed reactors comprises a fluidized catalyst bed disposed in the shell. In embodiments of the invention, the fluidized catalyst bed comprises a catalyst including ZSM-5 zeolites, HZSM-5 modified with La₂O₃/P₂O₅, molecular sieves, alumina, silica, or combinations thereof. The catalyst may further comprise a supporting material including slumina, silica, zirconium, or combinations thereof. The catalyst may have a particle density of 120 to 240 kg/m³ and all ranges and value there between including ranges of 120 to 130 kg/m³, 130 to 140 kg/m³, 140 to 150 kg/m³, 150 to 160 kg/m³, 160 to 170 kg/m³, 170 to 180 kg/m³, 180 to 190 kg/m³, 190 to 200 kg/m³, 200 to 210 kg/m³, 210 to 220 kg/m³, 220 to 230 kg/m³, and 230 to 240 kg/m³. According to embodiments of the invention, the fluidized catalyst bed may have a catalyst to oil ratio in a range of 10 to 80 and all ranges and values there between including ranges of 10 to 17, 17 to 24, 24 to 31, 31 to 38, 38 to 45, 45 to 52, 52 to 59, 59 to 66, 66 to 73, and 73 to 80.

According to embodiments of the invention, system 100 may further include pre-heater 102 disposed upstream to the feed inlet of the fluidized bed reactor. The pre-heater may be configured to heat feed stream 11 and produce heated feed stream 15. The pre-heater may be adapted to heat feed stream 11 to a temperature in a range of 200 to 550° C. and all ranges and values there between including ranges of 200 to 250° C., 250 to 300° C., 300 to 350° C., 350 to 400° C., 400 to 450° C., 450 to 500° C., and 500 to 550° C. In embodiments of the invention, an outlet of preheater 102 is in fluid communication with the feed inlet of fluidized bed reactor(s) such that heated feed stream 15 flows from preheater 102 to the one or more fluidized bed reactors of reaction unit 101.

In embodiments of the invention, an effluent outlet of the one or more fluidized bed reactor is in fluid communication with an inlet of solid-gas separation unit 103 such that effluent stream 12 flows from the fluidized bed reactor(s) to solid-gas separation unit 103. In embodiments of the invention, solid-gas separation unit 103 is configured to separate effluent stream 12 into spent catalyst stream 16 and gaseous product stream 17. In embodiments of the invention, solid-gas separation unit 103 may include one or more cyclone system. In embodiments of the invention, spent catalyst stream includes the catalyst particles with carbon deposit. Spent catalyst stream 16 may further include additional hydrocarbons absorbed on the catalyst particles.

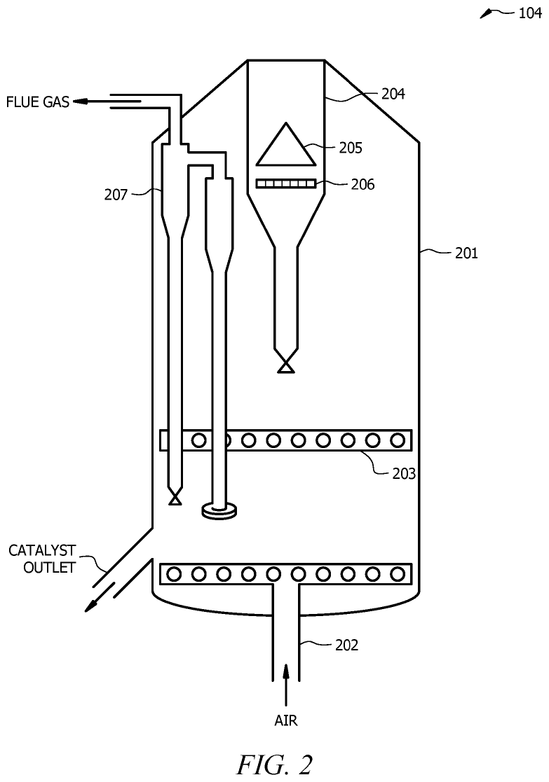

According to embodiments of the invention, a first outlet of solid-gas separation unit 103 may be in fluid communication with catalyst regeneration unit 104 such that spent catalyst stream 16 flows from solid-gas separation unit 103 to catalyst regeneration unit 104. In embodiments of the invention, catalyst regeneration unit 104 is configured to regenerate spent catalyst from spent catalyst stream 16 to produce catalyst stream 14 that comprises regenerated catalyst. In embodiments of the invention, as shown in FIG. 2, catalyst regeneration unit 104 includes shell 201 configured to host regeneration of the catalyst. According to embodiments of the invention, catalyst regeneration unit 104 includes regeneration gas inlet 202 adapted to receive regeneration gas stream 18 into catalyst regeneration unit 104. Regeneration gas inlet 202 may be disposed at the bottom of shell 201. Non-limiting examples of regeneration gas can include air, oxygen, nitrogen, methane, or combinations thereof.

According to embodiments of the invention, catalyst regeneration unit 104 includes one or more spargers 203 configured to inject a gaseous fuel amongst the catalyst particles disposed in catalyst regeneration unit 104. The gaseous fuel may include natural gas, methane, CO₂, nitrogen, or combinations thereof. In embodiments of the invention, one or more spargers 203 is disposed in dense phase of the catalyst particles in catalyst regeneration unit 104. One or more spargers 203 may include upward and/or downward facing nozzles. According to embodiments of the invention, one or more spargers 203 is adapted to inject the gaseous fuel into the catalyst such that substantially no flame or explosion occurs in catalyst regeneration unit 104 when the gaseous fuel is burned. The heat released by burning the gaseous fuel is sufficient to heat the catalyst particles to a temperature optimized for catalytic cracking the hydrocarbons in fluidized bed reactors of reaction unit 101. In embodiments of the invention, the temperature optimized for catalytic cracking the hydrocarbons in fluidized bed reactors of reaction unit 101 is in a range of 600 to 750° C. and all ranges and values there between including ranges of 600 to 610° C., 610 to 620° C., 620 to 630° C., 630 to 640° C., 640 to 650° C., 650 to 660° C., 660 to 670° C., 670 to 680° C., 680 to 690° C., 690 to 700° C., 700 to 710° C., 710 to 720° C., 720 to 730° C., 730 to 740° C., and 740 to 750° C. In embodiments of the invention, one or more spargers 203 is configured to inject the gaseous fuel into catalyst regeneration unit 104 in multi-stages such that the heat generated by burning the gaseous fuel is substantially evenly distributed in the catalyst.

In embodiments of the invention, system 100 may further include stripper 204 disposed upstream to catalyst regeneration unit 104. Stripper 204 may be configured to strip hydrocarbons absorbed on the catalyst particles before spent catalyst stream 16 enters catalyst regeneration unit 104. Stripper 204 may include stripping gas distributor 206 configured to release stripping gas into stripper 204. Stripping gas may comprise steam, CH₄, CO₂, nitrogen, or combinations thereof. Stripper 204 may further include stripping internal 205 comprising disk structured internals, chevron structured internals, packing internals, subway grating internals, or combinations thereof. According to embodiments of the invention, catalyst regeneration unit 104 further includes one or more cyclone systems 207 configured to separate flue gas from catalyst particles in catalyst regeneration unit 104. The flue gas may include methane, nitrogen, any inert gas, or combinations thereof. In embodiments of the invention, catalyst regeneration unit 104 includes a catalyst outlet configured to release regenerated and heated catalyst from shell 201 of catalyst regeneration unit 104.

In embodiments of the invention, as shown in FIG. 1, the catalyst outlet of catalyst regeneration unit 104 may be in fluid communication with the catalyst inlet of each of fluidized bed reactors such that regenerated catalyst of catalyst stream flows from catalyst regeneration unit 104 to reaction unit 101. According to embodiments of the invention, makeup catalyst stream 19 containing fresh catalyst particles may be combined with catalyst stream 14 before it flows to reaction unit 101.

According to embodiments of the invention, a second outlet of solid-gas separation unit 103 is in fluid communication with product separation unit 105 such that gaseous product stream 17 flows from solid-gas separation unit 103 to product separation unit 105. In embodiments of the invention, product separation unit 105 is configured to separate gaseous product stream 17 to produce recycle stream 20 and a plurality of product streams. The plurality of product streams can include one or more of an ethylene stream comprising primarily ethylene, a propylene stream comprising primarily propylene, and a BTX stream comprising primarily benzene, toluene, xylene, collectively. The product streams may further comprise one or more C₄ streams comprising butadiene, isobutene, 1-butene, 2-butene, or combinations thereof. According to embodiments of the invention, recycle stream 20 comprises C₅ to C₁₂ hydrocarbons. Recycle stream 20 may further include C₄ paraffins. According to embodiments of the invention, product separation unit includes one or more quench towers, one or more compressors, one or more BTX extraction units, one or more distillation columns, one or more wash towers, one or more hydrogenation units, one or more caustic towers, one or more acid and oxygen removal units, or any combination thereof.

In embodiments of the invention, an outlet of product separation unit 105 may be in fluid communication with an inlet of pre-heater 102 such that recycle stream 20 combines with feed stream 11 before flowed into reaction unit 101. According to embodiments of the invention, multiple fluidized bed reactors of reaction unit 101 can be operated with a single unit of solid-gas separation unit 103, a single unit of catalyst regeneration unit 104, and/or a single unit of product separation unit 105.

B. Method of Producing an Olefin and/or an Aromatic

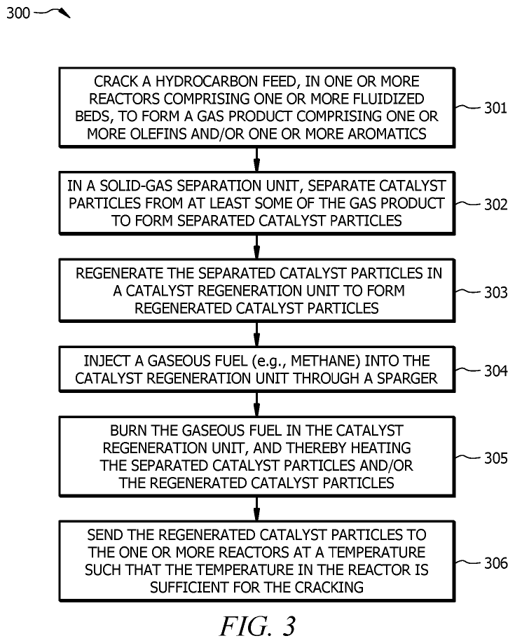

Methods of producing olefins and aromatics via catalytic cracking naphtha have been discovered. Embodiments of the method are capable of restoring sufficient heat to regenerated catalyst such that the catalytic cracking are conducted at an optimized reaction temperature. As shown in FIG. 3, embodiments of the invention include method 300 for producing an olefin and/or an aromatic. Method 300 may be implemented by system 100, as shown in FIG. 1, and catalyst regeneration unit 104, as shown in FIG. 2.

According to embodiments of the invention, as shown in block 301, method 300 includes cracking hydrocarbons of feed stream 11, in one or more reactors of reaction unit 101 comprising one or more fluidized beds, to form a gas product in effluent stream 12 comprising one or more olefins and/or one or more aromatics. In embodiments of the invention, feed stream 11 has an initial boiling point in a range of 30 to 70° C. and all ranges and values there between including ranges of 30 to 32° C., 32 to 34° C., 34 to 36° C., 36 to 38° C., 38 to 40° C., 40 to 42° C., 42 to 44° C., 44 to 46° C., 46 to 48° C., 48 to 50° C., 50 to 52° C., 52 to 54° C., 54 to 56° C., 56 to 58° C., 58 to 60° C., 60 to 62° C., 62 to 64° C., 64 to 66° C., 66 to 68° C., and 68 to 70° C. The hydrocarbon feed of feed stream 11 may comprise primarily naphtha with a final boiling point lower than 350° C.

According to embodiments of the invention, the one or more olefins in effluent stream 12 comprises ethylene, propylene, butylene, or combinations thereof. The one or more aromatics in effluent stream 12 may comprise benzene, toluene, xylene, or combinations thereof. In embodiments of the invention, the cracking at block 301 may be carried out at a reaction temperature in a range of 600 to 750° C. and all ranges and values there between including ranges of 600 to 610° C., 610 to 620° C., 620 to 630° C., 630 to 640° C., 640 to 650° C., 650 to 660° C., 660 to 670° C., 670 to 680° C., 680 to 690° C., 690 to 700° C., 700 to 710° C., 710 to 720° C., 720 to 730° C., 730 to 740° C., and 740 to 750° C. The cracking at block 301 may be carried out at a pressure, within the one or more reactors, in a range of 0.5 to 5 bar and all ranges and values there between including ranges of 0.5 to 1.0 bar, 1.0 to 1.5 bar, 1.5 to 2.0 bar, 2.0 to 2.5 bar, 2.5 to 3.0 bar, 3.0 to 3.5 bar, 3.5 to 4.0 bar, 4.0 to 4.5 bar, and 4.5 to 5.0 bar. According to embodiments of the invention, in the cracking step at block 301, the contact time between the catalyst particles and hydrocarbons in reaction unit 101 is in a range of 1 to 10 s and all ranges and values there between including ranges of 1 to 2 s, 2 to 3 s, 3 to 4 s, 4 to 5 s, 5 to 6 s, 6 to 7 s, 7 to 8 s, 8 to 9 s, and 9 to 10 s.

In embodiments of the invention, the one or more reactors in reaction unit 101 comprises one or more circulating fluidized bed reactors. In the cracking step at block 301, the fluidized bed in each of the one or more reactors may have a solid volume fraction of 0.1 to 0.2 and all ranges and values there between including ranges of 0.1 to 0.12, 0.12 to 0.14, 0.14 to 0.16, 0.16 to 0.18, and 0.18 to 0.20. The superficial velocity in the fluidized bed of each of one or more reactors may be in a range of 1 to 1.5 m/s and all ranges and values there between including ranges of 1 to 1.1 m/s, 1.1 to 1.2 m/s, 1.2 to 1.3 m/s, 1.3 to 1.4 m/s, and 1.4 to 1.5 m/s. The residence time distribution in each of the one or more fluidized bed reactors may be characterized as reactants, including the catalyst particles and/or hydrocarbons in the fluidized bed reactor, have a residence time in a range of 1 to 10 s.

According to embodiments of the invention, as shown in block 302, method 300 includes, in solid-gas separation unit 103, separating catalyst particles from at least some of the gas product of effluent stream 12 to form (a) separated catalyst particles in spent catalyst stream 16 and (b) gaseous product stream 17. The separating at block 302 may be conducted in single staged or multi-staged cyclone systems in solid-gas separation unit 103. In embodiments of the invention, gaseous product stream 17 is further separated in product separation unit 105 to form one or more of an ethylene stream comprising primarily ethylene, a propylene stream comprising primarily propylene, a C₄ olefins stream comprising primarily C₄ olefins, and a BTX stream comprising primarily benzene, toluene, xylene, collectively.

According to embodiments of the invention, as shown in block 303, method 300 includes regenerating the separated catalyst particles of spent catalyst stream 16 in catalyst regeneration unit 104, to form regenerated catalyst particles. In embodiments of the invention, regenerating at block 303 may include burning carbon deposit on the catalyst particles in regeneration gas (e.g., air). In embodiments of the invention, prior to regenerating at block 303, catalyst particles of spent catalyst stream 16 may be stripped of hydrocarbons absorbed thereon in stripper 204. In embodiments of the invention, the regenerating at block 303 may be conducted at a regeneration temperature of 500 to 650° C. and all ranges and values there between including ranges of 500 to 510° C., 510 to 520° C., 520 to 530° C., 530 to 540° C., 540 to 550° C., 550 to 560° C., 560 to 570° C., 570 to 580° C., 580 to 590° C., 590 to 600° C., 600 to 610° C., 610 to 620° C., 620 to 630° C., 630 to 640° C., and 640 to 650° C.

According to embodiments of the invention, as shown in block 304, method 300 includes injecting the gaseous fuel into catalyst regeneration unit 104 through sparger 203. In embodiments of the invention, the gaseous fuel is injected into catalyst regeneration unit 104 in a single stage or multi-stages. The gaseous fuel injected at block 304 may include methane, natural gas, nitrogen, methane, CO₂, or combinations thereof. In embodiments of the invention, sparger 203 is located in dense phase of catalyst particles in catalyst regeneration unit 104.

In embodiments of the invention, as shown in block 305, method 300 includes burning the gaseous fuel (e.g., methane) in catalyst regeneration unit 104 and thereby heating the separated catalyst particles and/or the regenerated catalyst particles. According to embodiments of the invention, the burning at block 305 creates substantially no flame (i.e., flameless combustion) or explosion in catalyst regeneration unit 104.

In embodiments of the invention, at block 306, method 300 further comprises sending the regenerated catalyst particles of catalyst stream 14 to the one or more reactors of reaction unit 101 at a temperature such that the temperature in the reactor is sufficient for the cracking.

Although embodiments of the present invention have been described with reference to blocks of FIG. 3, it should be appreciated that operation of the present invention is not limited to the particular blocks and/or the particular order of the blocks illustrated in FIG. 3. Accordingly, embodiments of the invention may provide functionality as described herein using various blocks in a sequence different than that of FIG. 3.

In the context of the present invention, at least the following 15 embodiments are described. Embodiment 1 is a method of producing an olefin and/or aromatic. The method includes cracking a hydrocarbon feed, in a reactor including a fluidized bed, to form a gas product containing one or more olefins and/or one or more aromatics. The method further includes separating catalyst particles from at least some of the gas product to form separated catalyst particles. The method still further includes regenerating the separated catalyst particles, in a catalyst regeneration unit, to form regenerated catalyst particles, and injecting methane into the catalyst regeneration unit through a sparger. The method also includes burning the methane, in the catalyst regeneration unit, and thereby heating the separated catalyst particles and/or the regenerated catalyst particles. In addition, the method includes sending the regenerated catalyst particles to the reactor at a temperature such that the temperature in the reactor is sufficient for the cracking. Embodiment 2 is the method of embodiment 1, wherein the hydrocarbon feed has an initial boiling point in a range of 30 to 70° C. Embodiment 3 is the method of either of embodiments 1 or 2, wherein the hydrocarbon feed contains primarily naphtha with a final boiling point lower than 350° C. Embodiment 4 is the method of any of embodiments 1 to 3, wherein the one or more olefins include ethylene, propylene, butylene, or combinations thereof. Embodiment 5 is the method of any of embodiments 1 to 4, wherein the one or more aromatics include benzene, toluene, xylene, or combinations thereof. Embodiment 6 is the method of any of embodiments 1 to 5, wherein the methane is included in a natural gas stream. Embodiment 7 is the method of any of embodiments 1 to 6, wherein the reactor includes a circulating fluidized bed reactor. Embodiment 8 is the method of any of embodiments 1 to 7, wherein the methane is injected in a dense phase of the catalyst in the catalyst regeneration unit. Embodiment 9 is the method of any of embodiments 1 to 8, wherein the cracking is performed at a reaction temperature, within the reactor, in a range of 600 to 750° C. Embodiment 10 is the method of any of embodiments 1 to 9, wherein the cracking is performed at an average contact time for catalyst and hydrocarbon in a range of 1 to 10 s. Embodiment 11 is the method of any of embodiments 1 to 10, wherein the cracking is performed at a reaction pressure, within the reactor, in a range of 0.5 to 5.0 bar. Embodiment 12 is the method of any of embodiments 1 to 11, wherein the temperature of the regenerated catalyst sufficient for cracking is in a range of 500 to 750° C. Embodiment 13 is the method of any of embodiments 1 to 12, wherein the methane is injected in multiple stages. Embodiment 14 is the method of any of embodiments 1 to 13, wherein the sparger includes upward and/or downward facing nozzles. Embodiment 15 is the method of any of embodiments 1 to 14, wherein the burning of the methane in the catalyst regeneration unit includes flameless combustion.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of producing an olefin and/or aromatic, the method comprising:
cracking a hydrocarbon feed, in a reactor comprising a fluidized bed, to form a gas product comprising one or more olefins and/or one or more aromatics;
separating catalyst particles from at least some of the gas product to form separated catalyst particles;
regenerating the separated catalyst particles, in a catalyst regeneration unit, to form regenerated catalyst particles;
injecting methane into the catalyst regeneration unit through a sparger;
burning the methane, in the catalyst regeneration unit, and thereby heating the separated catalyst particles and/or the regenerated catalyst particles; and
sending the regenerated catalyst particles to the reactor at a temperature such that the temperature in the reactor is sufficient for the cracking.

2. The method of claim 1, wherein the hydrocarbon feed has an initial boiling point in a range of 30 to 70° C.

3. The method of claim 1, wherein the hydrocarbon feed comprises primarily naphtha with a final boiling point lower than 350° C.

4. The method of claim 1, wherein the one or more olefins include ethylene, propylene, butylene, or combinations thereof.

5. The method of claim 1, wherein the one or more aromatics include benzene, toluene, xylene, or combinations thereof.

6. The method of claim 1, wherein the methane is included in a natural gas stream.

7. The method of claim 1, wherein the reactor comprises a circulating fluidized bed reactor.

8. The method of claim 1, wherein the methane is injected in a dense phase of the catalyst in the catalyst regeneration unit.

9. The method of claim 1, wherein the cracking is performed at a reaction temperature, within the reactor, in a range of 600 to 750° C.

10. The method of claim 1, wherein the cracking is performed at an average contact time for catalyst and hydrocarbon in a range of 1 to 10 s.

11. The method of claim 1, wherein the cracking is performed at a reaction pressure, within the reactor, in a range of 0.5 to 5.0 bar.

12. The method of claim 1, wherein the temperature of the regenerated catalyst sufficient for cracking is in a range of 500 to 750° C.

13. The method of claim 1, wherein the methane is injected in multiple stages.

14. The method of claim 1, wherein the sparger comprises upward and/or downward facing nozzles.

15. The method of claim 1, wherein the burning of the methane in the catalyst regeneration unit comprises flameless combustion.

16. The method of claim 3, wherein the burning of the methane in the catalyst regeneration unit comprises flameless combustion.

17. The method of claim 4, wherein the burning of the methane in the catalyst regeneration unit comprises flameless combustion.

18. The method of claim 5, wherein the burning of the methane in the catalyst regeneration unit comprises flameless combustion.

19. The method of claim 6, wherein the burning of the methane in the catalyst regeneration unit comprises flameless combustion.

20. The method of claim 7, wherein the burning of the methane in the catalyst regeneration unit comprises flameless combustion.
